(19) United States
(12) Patent Application Publication
(10) Pub. No.: US 2012/0118876 A1
(43) Pub. Date: May 17, 2012

(54) FLIP CHIP BONDING APPARATUS AND MANUFACTURING METHOD THEREOF

(75) Inventors: Jung Hyun Cho, Suwon-si (KR); Yury Tolmachev, Suwon-si (KR); Sang Jean Jeon, Hwaseong-si (KR); Byung Joon Lee, Yongin-si (KR); Jae Bong Shin, Gunpo-si (KR); Hyungjoon Kim, Seoul (KR); Moon Seok Kim, Seoul (KR)

(73) Assignee: SAMSUNG ELECTRONICS CO., LTD., Suwon-si (KR)

(21) Appl. No.: 13/289,525

(22) Filed: Nov. 4, 2011

(30) Foreign Application Priority Data
Nov. 12, 2010 (KR) 10-2010-0112502

(51) Int. Cl. H05B 6/10

(52) U.S. Cl. 219/635

(57) ABSTRACT

According to example embodiments, a flip chip bonding apparatus includes a metal chamber, a stage in the metal chamber, and a planar antenna in the chamber. The stage may be configured to receive a circuit board having flip chips arranged thereon. The antenna may be configured to bond the flip chips to the circuit board by inductively heating the flip chips on the circuit board.

### CROSS-REFERENCE TO RELATED APPLICATION

This application claims priority under 35 U.S.C. §119 to the benefit of Korean Patent Application No. 2010-112502 filed on Nov. 12, 2010 with the Korean Intellectual Property Office, the entire contents of which are incorporated herein by reference.

### BACKGROUND

1. Field

Example embodiments relate to a flip chip bonding apparatus and a manufacturing method thereof and, more particularly, to a flip chip bonding apparatus to bond and fix a flip chip to a substrate and a method for manufacturing the same.

2. Description of the Related Art

Conventional methods for connecting and bonding IC chips to a printed circuit board include wire bonding processes that may use a fine gold or aluminum wire. Wire bonding processes generally involve forming a metal pad used as an input/output terminal around a peripheral side of a flip chip.

A flip chip bonding process may be used to connect IC chips to a substrate, for example a printed circuit board. Flip chip bonding processes may include forming a solder bump on a rear side of the IC chip and reflowing the same to allow the solder bump to be fixed to the circuit board by heat plate bonding, thereby bonding the IC chips to the circuit board.

Flip chip bonding processes may include: forming a solder bump on an IC chip, arranging the IC chip with a metal pad on a circuit board, and heating both the IC chip and the circuit board to above a melting point of the solder bump by infrared heating or convective heating in order to reflow the solder bump, that is, to dissolve the solder bump, in turn enabling the solder bump of the IC chip to be bonded to the metal pad of the circuit board.

However, in such a flip chip bonding process through IR heating or convective heating, an IC chip and a polymer circuit board may be heated to a high temperature ranging from 200 to 300° C. for reflowing a solder bump.

Conventional flip chip bonding methods using inductive heating may induce a magnetic field by a solenoid coil. The intensity of an alternating current (AC) magnetic field induced by a solenoid coil can be irregular. Thus, uniformly transferring heat to a solder bump can be difficult when using conventional flip chip bonding methods using inductive heating.

### SUMMARY

Example embodiments relate to a flip chip bonding apparatus which includes a planar antenna located adjacent a flip chip to generate an AC magnetic field, in turn enabling inductive heating, so as to bond the flip chip to a circuit board, as well as a method for manufacturing the same.

According to example embodiments, a flip-chip bonding apparatus includes: a metal chamber; a stage in the metal chamber, the stage configured to receive a circuit board having one or more flip chips arranged thereon, and a planar antenna. The planar antenna may be configured to bond the flips chips to the circuit board by inductively heating the flip chips on the circuit board.

The apparatus may include a metal frame. The metal frame may be spaced apart from the planar antenna by a gap, the metal frame may be configured to allow a uniform AC magnetic field to be generated around the planar antenna.

The planar antenna may include a peripheral side, a top surface, and a bottom surface. The metal frame may surround the peripheral side of the planar antenna.

The planar antenna may include a zig-zag form. A width of the planar antenna may be about equal to or greater than a width of the circuit board, and a breadth of the planar antenna may be about equal to or greater than a breadth of the circuit board.

The apparatus may further include a metal plate below the circuit board, and the metal plate may define a plurality of vacuum holes. The vacuum holes may be configured to be vacuum chucked in order to reduce the circuit board from being bent.

The metal plate may include a nickel-iron alloy.

The metal chamber may define a through-hole. The planar antenna may be fixed above the stage via the through-hole.

The apparatus may further include a first terminal and a second terminal. The first and second terminals may be both connected to a side of the planar antenna. A high frequency AC power supply may be connected to the first terminal. A ground may be connected to the second terminal.

The metal chamber may define at least one through-hole, through which the first and second terminals are inserted. The first and second terminals may be configured to fix the planar antenna above the stage.

The planar antenna may further include a third terminal and a fourth terminal. The third and fourth terminals may be both connected to an opposite side of the planar antenna. A first balance capacitor may be connected to the third and fourth terminals. A second balance capacitor may be connected to the second terminal and the ground. The first balance capacitor and the second balance capacitor may be configured to reduce arc discharge between the circuit board and the planar antenna.

According to example embodiments, a method for manufacturing a flip chip bonding apparatus, includes: preparing a metal chamber; placing a stage in the metal chamber so the stage is configured to receive a circuit board having one or more flip chips arranged thereon, and providing a planar antenna in the metal chamber above the stage. The planar antenna may be configured to bond the flip chips to the circuit board by inductively heating the flip chips.

The planar antenna may include a zig-zag form. A width of the planar antenna may be about equal to or greater than a width of the circuit board, and a breadth of the planar antenna may be about equal to or greater than a breadth of the circuit board.

The metal chamber may define a through-hole, and the planar antenna may be fixed above the stage via the through-hole.

The method may further include connecting a first terminal and a second terminal to a side of the planar antenna, connecting the first terminal to a high frequency AC power supply, and connecting the second terminal to a ground.

The method may include forming a through-hole in the metal chamber, and fixing the planar antenna above the stage by inserting the first and second terminals into the through-hole.

The method may include connecting a plurality of balance capacitors to the planar antenna in order to reduce arc discharge between the circuit board and the planar antenna.

The method may include arranging a metal frame to be separated from the planar antenna by a gap. The metal frame may be configured in order to allow a uniform AC magnetic field to be generated around the planar antenna.

The planar antenna may include a peripheral side, a top surface, and a bottom surface. The method may include arranging a metal frame to surround a peripheral side of the planar antenna.

The metal frame may be made of copper (Cu).

As described above, the flip chip bonding apparatus and the method for manufacturing the same according to the foregoing aspects may apply AC power to a planar antenna and, using an AC magnetic field generated by applied AC power, uniformly heat a flip chip and a circuit board.

Using a larger planar antenna in a zig-zag form than a size of a circuit board, several tens of flip chips may be bonded at once, may decrease the processing time.

Moreover, by connecting a balance capacitor to the antenna, arc discharge between the antenna and the circuit board may be reduced (and/or prevented).

### BRIEF DESCRIPTION OF THE DRAWINGS

These and/or other aspects of the example embodiments will become apparent and more readily appreciated from the following description of non-limiting example embodiments, taken in conjunction with the accompanying drawings in which like reference characters refer to the same parts throughout the different views. The drawings are not necessarily to scale, emphasis instead being placed upon illustrating the principles of example embodiments. In the drawings:

FIG. 1 is a cross-sectional view illustrating a flip chip and a circuit board bonded together using a flip chip bonding apparatus according to example embodiments;

FIG. 2 is a cross-sectional view illustrating a flip chip bonding apparatus according to example embodiments;

FIG. 3 is a perspective view illustrating a planar antenna of the flip chip bonding apparatus shown in FIG. 2;

FIG. 4 is a schematic view illustrating a bonding condition of flip chips to a circuit board using the planar antenna shown in FIG. 3;

FIG. 5 is a cross-sectional view taken along lines V-V′ shown in FIG. 4;

FIG. 6 is a cross-sectional view illustrating a flip chip bonding apparatus according to example embodiments;

FIG. 7 is a perspective view illustrating a planar antenna of the flip chip bonding apparatus shown in FIG. 6;

FIG. 8 is graphs showing improved uniformity of an AC magnetic field generated in the planar antenna shown in FIG. 7;

FIG. 9 is a circuit diagram illustrating the central part of the planar antenna shown in FIG. 7; and

FIG. 10 is a flow chart explaining a process of manufacturing a flip chip bonding apparatus according to example embodiments.

### DETAILED DESCRIPTION

Example embodiments will now be described more fully with reference to the accompanying drawings, in which some example embodiments are shown. Example embodiments, may, however, be embodied in many different forms and should not be construed as being limited to the embodiments set forth herein; rather, these example embodiments are provided so that this disclosure will be thorough and complete, and will fully convey concepts of example embodiments to those of ordinary skill in the art. In the drawings, the thicknesses of layers and regions are exaggerated for clarity. Like reference numerals in the drawings denote like elements, and thus their description will be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

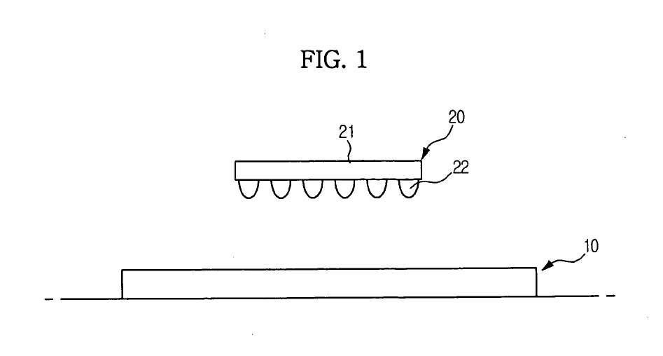

FIG. 1 is a cross-sectional view illustrating a flip chip and a circuit board bonded together using a flip chip bonding apparatus according to example embodiments.

As shown in FIG. 1, the flip chip bonding apparatus according to example embodiments is an apparatus to adhere and fix a flip chip 20 to a circuit board 10, wherein the flip chip 20 comprises a planar die 21 and a plurality of solder bumps 22 protruding from one side of the die 21 in order to allow the die 21 to be connected to a circuit board 10.

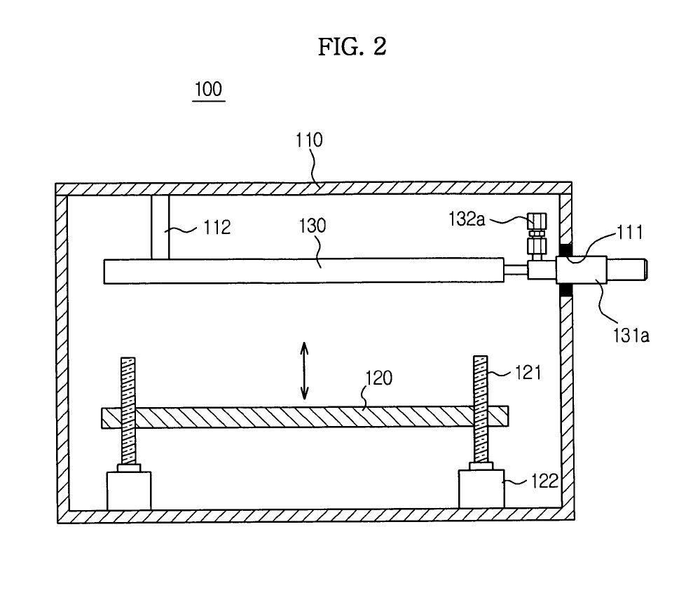

FIG. 2 is a cross-sectional view illustrating a flip chip bonding apparatus according to example embodiments.

A flip chip bonding apparatus 100 according to example embodiments includes a metal chamber 110, a stage 120, and a planar antenna 130.

The stage 120 is placed in the metal chamber 110, such that the circuit board having the flip chip arranged thereon is placed on the stage. The stage 120 is connected to a feed screw 121 and a motor 122 in order to move the stage up and down, thereby controlling a space between the circuit board and the planar antenna 130.

The planar antenna 130 is placed in the metal chamber 110 and inductively heats the flip chip to allow the flip chip to be bonded to the circuit board. The planar antenna 130 is fixed to the top of the stage 120, via a through-hole 111 made of an insulating material and formed in the metal chamber 110.

A terminal 131a of the planar antenna 130 may be connected to a high frequency AC power supply and a ground. The terminal 131a may be inserted into the through-hole 111. One side of the planar antenna 130 may be fixed to the metal chamber 110 and above the stage 120 by a support 112 fixed to an inner top side of the metal chamber 110. The other side of the planar antenna 130 may be fixed above the stage 120 via the through-hole (111). The support 112 may be provided in plural, so as to stably fix the planar antenna 130.

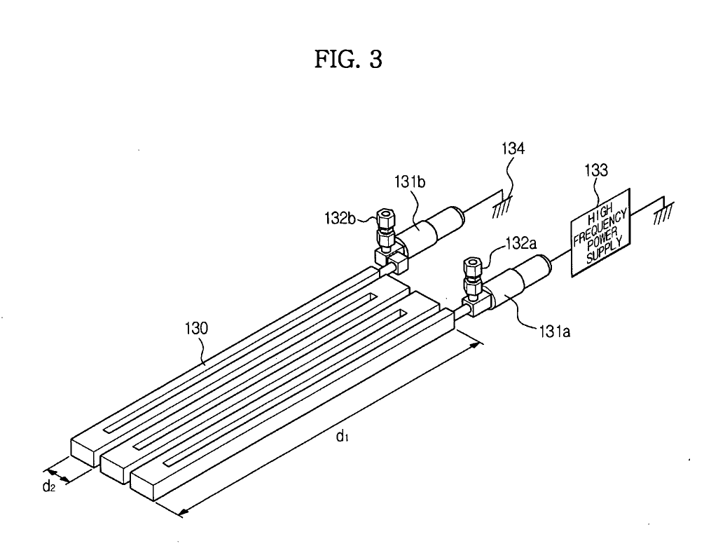

FIG. 3 is a perspective view illustrating the planar antenna shown in FIG. 2.

The planar antenna 130 according to example embodiments may be formed in a zig-zag pattern such that bent parts at a right angle (‘bends’) are arranged at predetermined interval d1 and line interval d2. The interval d1 between adjacent bends and the line interval d2 may be controlled to improve (and/or optimize) the uniformity and the B-field magnitude of the AC magnetic field induced by the planar antenna 130.

Although the planar antenna 130 includes a zig-zag pattern according to example embodiments has been described, other patterns of planar antennas capable of generating an AC magnetic field, such as a spiral pattern, a pattern consisting of plural concentric circles, or the like, may also be included in the scope of example embodiments.

In addition, a width and a breadth of the planar antenna 130 may be substantially equal to or greater than those of the circuit board. Accordingly, it is possible to suitably design a plurality of flip chips arranged on the circuit board to be heated simultaneously, in turn being bonded thereto.

That is, the planar antenna 130 may be configured to be larger than the circuit board or to be the same size as the circuit board, in order to heat a large area circuit board at once. As a result, the processing time may be considerably reduced, compared to a process of heating a substrate on which flip chips are placed while transporting the same.

Meanwhile, the planar antenna 130 may be made of a silver-plated copper, however, the material is not particularly limited so long as it is a metal having high conductivity.

The planar antenna 130 may further include a plurality of connection terminals 131a and 131b to be connected to a high frequency power supply 133 and a ground 134, respectively. The connection terminals 131a and 131b are located on one side of the planar antenna 130 and may be circular terminals.

In this regard, the high frequency power supply 133 may include a high frequency generator (not shown) generating AC power at a high frequency of 27.12 MHz or 13.56 MHz, and a matching part (not shown) to match impedance between the high frequency generator and the planar antenna 130.

In order to cool the planar antenna 130 heated by the high frequency AC power, cooling water ports 132a and 132b may be further included. These cooling water ports 132a and 132b are ports to be connected to a cooling flow path through which cooling water is introduced. These are substantially an input port and an output port, respectively.

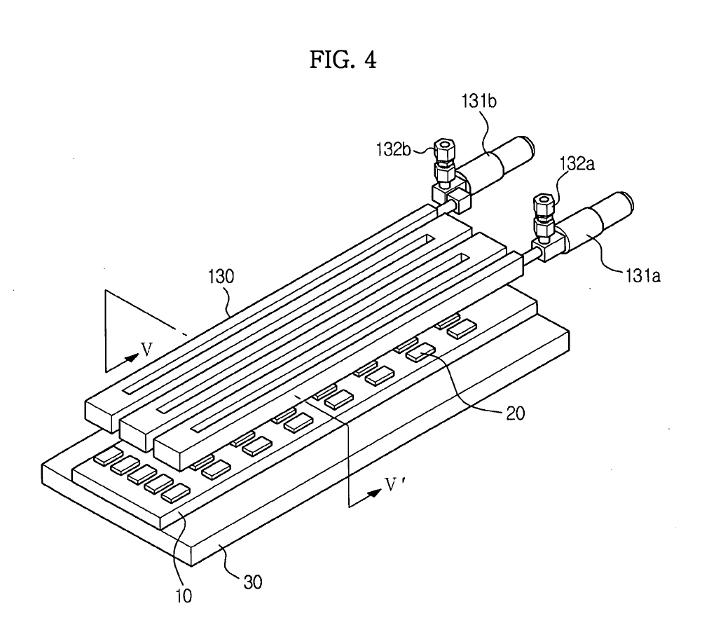

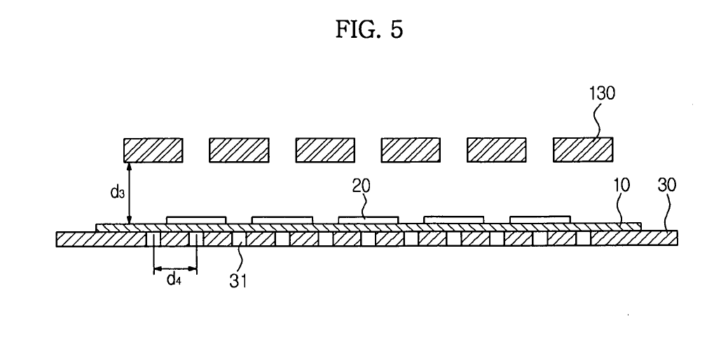

FIG. 4 is a schematic view illustrating a bonding condition of flip chips to a circuit board using the planar antenna shown in FIG. 3, and FIG. 5 is a cross-sectional view taken along lines V-V′ shown in FIG. 4.

Referring to FIGS. 4 and 5, in order to bond flip chips 20 to a circuit board 10, the circuit board 10 on which several tens of flip chips 20 are arranged at a desired (or alternatively predetermined) interval is positioned below the planar antenna 130 while being apart therefrom at a desired (or alternatively predetermined) spacing.

The spacing described above is preferably designed to be narrow, so as to sufficiently heat the circuit board using the planar antenna 130. In example embodiments, the circuit board may be located 2 to 3 mm below the planar antenna.

As such, after placing the circuit board 10 on which several tens of flip chips 20 are arranged at a desired (or alternatively predetermined) interval below the planar antenna 130, high frequency AC power is applied thereto in order to bond the flip chips 20 to the circuit board 10. A principle of bonding the flip chips 20 to the circuit board 10 using the planar antenna 130 will be described as follows.

When high frequency AC power is applied to an antenna and the antenna is charged with current, a magnetic field is generated around the antenna. Here, if metal is present near the antenna, the metal is charged with eddy current by the applied magnetic field. Such eddy current heats the metal and this is referred to as inductive heating.

In the example embodiments, the circuit board 10 having flip chips 20 arranged thereon is placed below the planar antenna 130, on the basis of the foregoing principle. Then, applying the high frequency AC power to the planar antenna 130 may generate an AC magnetic field around the planar antenna 130. Because of the AC magnetic field, solder bumps of each flip chip are inductively heated by eddy current which in turn allows the flip chip 20 to be bonded to the circuit board 10.

Other than the solder bumps of the flip chips 20, a metal wire of the circuit board 10 is also heated during bonding the flip chips 20 to the circuit board by AC magnetic field of the planar antenna 130.

According to the example embodiments, a metal plate 30 is attached to the bottom of the circuit board. This metal plate 30 functions to dissipate heat of the circuit board 10, thus reduce (and/or prevent) local burning of the circuit board. Simultaneously, the metal plate 30 is heated by the AC magnetic field and this heat is transferred to the solder bumps, thereby contributing to heating of the solder bumps.

According to example embodiments, the metal plate 30 may be made of a material with reduced thermal deformation. For example, the metal plate 30 may be made of INVAR® (an alloy corresponding to the registered trademark of STE. AME. DE COMMENTRY FOURCHAMBAULT ET DECAZEVILLE CORPORATION), which is an alloy of Ni and Fe that is substantially inexpansible.

Meanwhile, the circuit board 10 is made of a non-conductive material and may be bent while the flip chips 20 are heated through inductive heating.

According to example embodiments, in order to reduce (and/or prevent) the circuit board 10 from being bent, a plurality of vacuum holes 31 may be formed on the metal plate 30 at a desired (or alternatively predetermined) interval d4. These vacuum holes 31 may be connected to a vacuum pump through a bypass pipeline equipped with a valve, so as to conduct vacuum chucking.

In other words, the circuit board 10 is adsorbed to the metal plate 30 by vacuum suction via the vacuum holes 31, thereby reducing (and/or preventing) the circuit board 10 from being bent due to heating.

The spacing interval d4 of adjacent vacuum holes 31 may be regulated depending upon a size of each flip chip 20 and an interval of arranging the flip chips 20 on the circuit board 10.

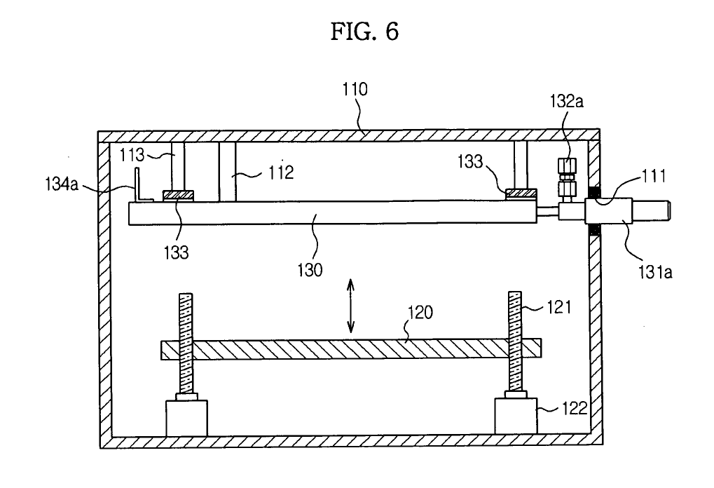

FIG. 6 is a cross-sectional view illustrating a flip chip bonding apparatus according to example embodiments.

The flip chip bonding apparatus 100 according to example embodiments includes a metal chamber 110, a stage 120 and a planar antenna 130.

The stage 120 is placed in the metal chamber 110, such that the circuit board having flip chips arranged thereon is placed on the stage. The stage 120 is connected to a feed screw 121 and a motor 122 in order to move the stage up and down.

The planar antenna 130 is placed in the metal chamber 110 and conducts inductive heating of the flip chips to allow the flip chips to be bonded to the circuit board. The planar antenna 130 is fixed to top of the stage 120, via a through-hole 111 made of an insulating material and formed in the metal chamber 110. In particular, a connection terminal 131a of the planar antenna 130 is inserted in a through-hole 111, and then, one side of the planar antenna 130 may be fixed above the stage 120. By a support 112 fixed to an inner top side of the metal chamber 110, the other side of the planar antenna 130 may be fixed to the metal chamber 110 and above the stage 120.

According to the example embodiments, the planar antenna 130 also may include a metal frame 133 around a peripheral side thereof. This metal frame 133 is fixed around the planar antenna 130 by the support 113, in order to be spaced from the planar antenna 130 by a desired (or alternatively predetermined) gap.

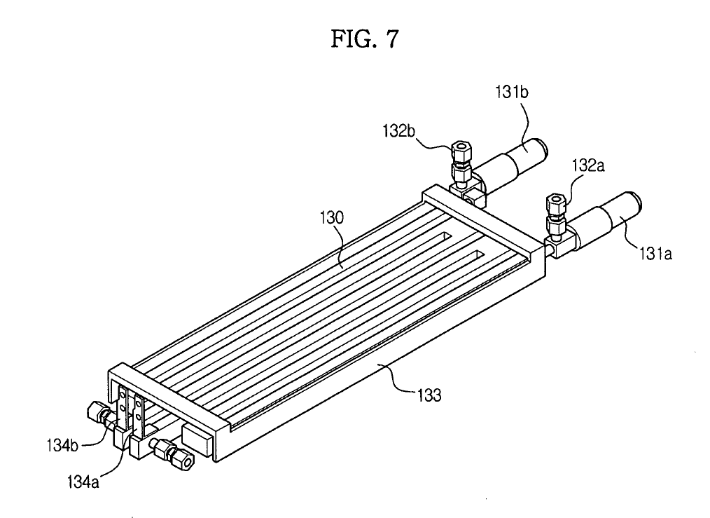

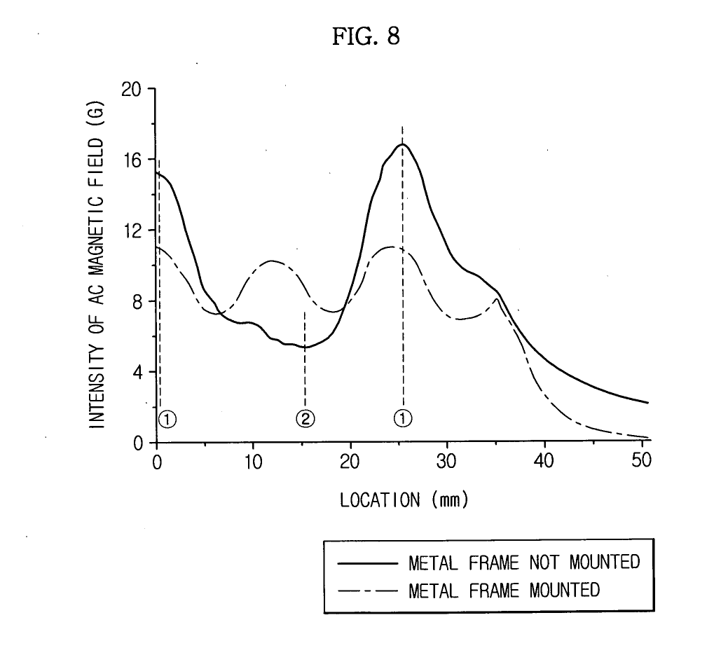

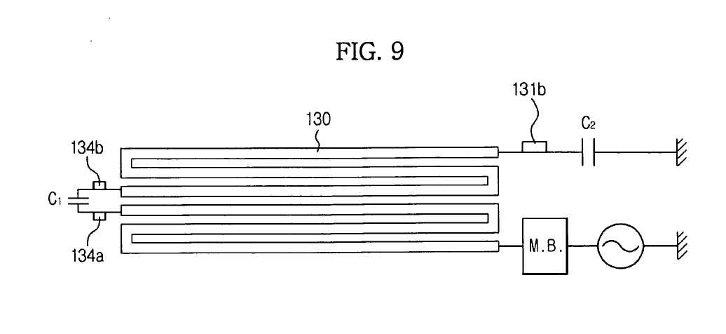

FIG. 7 is a perspective view illustrating the planar antenna of the flip chip bonding apparatus shown in FIG. 6. FIG. 8 is a graph that shows improved results of uniformity in AC magnetic field generated in the planar antenna shown in FIG. 7. FIG. 9 is a circuit diagram illustrating the planar antenna shown in FIG. 7 as the central part.

In the case where several tens of flip chips are bonded to a large area circuit board at once, the AC magnetic field intensity should be uniform. If the AC magnetic field is non-uniform, a part to which the AC magnetic field is strongly applied may be overheated and locally burnt. On the other hand, the other part to which a relatively low intensity AC magnetic field is applied may suffer from chip bonding failure.

According to example embodiments, a metal frame 133 is additionally provided to uniformly generate AC magnetic field around the planar antenna.

The metal frame 133 is configured in a closed loop form to allow top and bottom surfaces of the planar antenna 130 to be exposed, while surrounding a peripheral side of the planar antenna 130 except the top and bottom surfaces.

The metal frame 133 may be made of Cu, however, a material thereof is not particularly limited so long as it is a metal having high electrical conductivity.

FIG. 8 shows a distribution of AC magnetic field intensities around the planar antenna 130 having the metal frame 133, compared to the planar antenna without the metal frame 133.

Referring to FIG. 8, the AC magnetic field intensity where the metal frame 133 is not mounted (solid line) is slightly varied depending upon respective areas on the planar antenna. That is, a strength of induced eddy current is increased at a position (\textcircled{1}) where the AC magnetic field intensity is high, thus overheating the metal wire in the circuit board. On the other hand, at another position (\textcircled{2}) where the AC magnetic field intensity is relatively low, the strength of the induced eddy current is decreased, thus entailing insufficient heating of the solder bumps.

It can be seen from the foregoing figure that the AC magnetic field intensity when the metal frame is formed around the planar antenna (dotted line), is relatively uniform, compared to the planar antenna without the metal frame, thus improving non-uniformity of the AC magnetic field around the planar antenna. The reasons for such improvement in non-uniformity of AC magnetic field will be described as follows.

When a metal having a high electrical conductivity is arranged around the planar antenna, induced current may pass through the metal frame to reverse the direction of current flow through the planar antenna, which in turn forms an induced magnetic field in a direction counter to that of the magnetic field generated by the current of the planar antenna. This induced magnetic field provides compensation and/or reinforcement effects to the AC magnetic field formed around the planar antenna, thereby securing more uniform AC magnetic field intensity throughout the planar antenna.

Alternatively, if the metal frame is not present, edge effect in that the magnetic field is excessively strong at an edge area of the planar antenna, may be caused. Although a planar antenna having a broader area has been proposed to reduce (and/or prevent the edge) effect described above, it encounters difficulties in matching caused by increased impedance.

According to example embodiments, edge effect may be reduced (and/or prevented) by providing a metal frame around the planar antenna, thus enabling more uniform AC magnetic field intensity.

Therefore, a plurality of flip chips arranged on a large area circuit board may be simultaneously bonded, and flip chip bonding faults and/or overheating of the circuit board may be reduced (and/or effectively prevented).

As described above (see FIG. 5), the circuit board 10 and the planar antenna 130 are separated from each other by 2 to 3 mm, and AC power applied to the planar antenna 130 may be a high frequency power (with 27.12 MHz or 13.56 MHz).

Due to the foregoing, when high frequency AC power is applied to the planar antenna 130 to flow current while applying a desired (or alternatively predetermined) voltage to the planar antenna 130, arc discharge may occur between the planar antenna 130 and the circuit board 10 spaced therefrom by a desired (or alternatively predetermined) gap d3.

That is, the planar antenna 130, to which voltage is applied, and the circuit board 10 may form two electrodes and an electric discharge in an arc form may occur between these electrodes.

If a distance (d3) between the planar antenna 130 and the circuit board 10 is increased to reduce (and/or prevent) the foregoing arc discharge, heating efficiency may be decreased with reduction in the intensity of eddy current induced by the AC magnetic field, in turn prolonging a processing time.

Therefore, according to example embodiments, in order to effectively reduce (and/or prevent) the arc discharge while maintaining the distance d3 between the planar antenna 130 and the circuit board 10, a balance capacitor is connected to the planar antenna 130.

Referring to FIGS. 6 and 7, terminals 134a and 134b are on a lateral side of the planar antenna 130 to connect a balance capacitor thereto.

The balance capacitor connection terminals 134a and 134b are arranged on the middle of the lateral side of the planar antenna 130, whereas alternative connection terminals 131a and 131b for connecting the planar antenna to a ground and an AC power supply, respectively, are arranged opposite the foregoing terminals 134a and 134b.

Referring to FIG. 9, which is a circuit diagram showing the central part of the planar antenna shown in FIG. 7, example embodiments adopt two balance capacitors C1 and C2 for connection to planar antenna 130.

More particularly, a first balance capacitor C1 is connected to both connection terminals 134a and 134b for the balance capacitor while a second balance capacitor C2 is connected to the connection terminal 131b for a ground.

The first balance capacitor C1 is connected to one side of the planar antenna while the second balance capacitor C2 is connected to the other side thereof. In addition, a high frequency AC power supply and a matching box (M.B.) to match the impedance between this AC power supply and the planar antenna are also connected to the latter, that is, the other side.

Meanwhile, each of the balance capacitors C1 and C2 is a vacuum capacitor having capacitive impedance. The balance capacitors C1 and C2 are connected to the planar antenna 130, and may reduce overall impedance of the planar antenna 130. Accordingly, voltage generated by application of the high frequency AC power is decreased, in turn reducing a problem of arc discharge.

In this case, a capacitance of each of the first and second balance capacitors C1 and C2 may be controlled to considerably reduce the probability of arc discharge, in consideration of the impedance of the planar antenna 130.

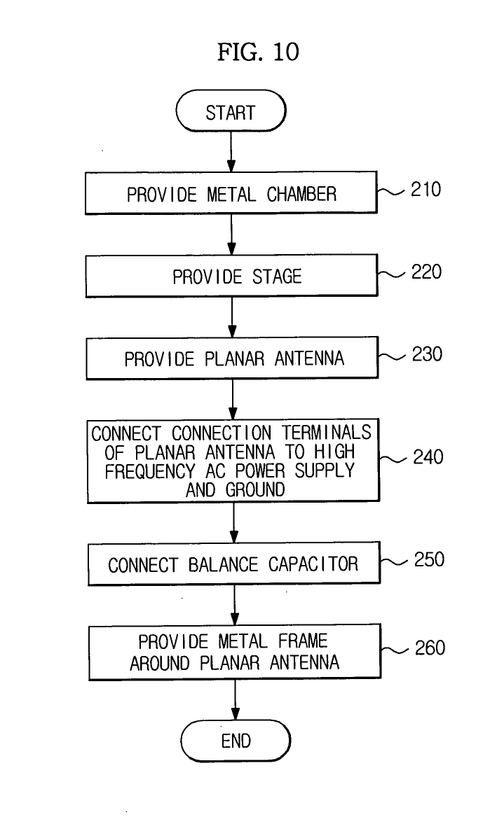

FIG. 10 is a flow chart explaining a process of manufacturing a flip chip bonding apparatus according to example embodiments.

A metal chamber is first prepared in operation 210. Then, a stage on which a circuit board having flip chips arranged thereon is provided, is placed in the metal chamber in operation 220.

The stage is connected to a plurality of feed screws and a motor in order to move the stage up and down.

After mounting the stage in operation 220, a planar antenna is placed in the metal chamber in operation 230 and located above the stage in order to conduct inductive heating of the flip chips.

The planar antenna is fixed above the top of the stage via a through-hole formed in the metal chamber. More particularly, one side of the planar antenna is fixed above the stage by inserting a connection terminal of the planar antenna into the through-hole. In addition, the other side of the planar antenna may be fixed to a support mounted on an inner top side of the metal chamber.

The planar antenna may be made of a metallic material having a high electrical conductivity. In example embodiments, the planar antenna may be made of silver plated copper.

The planar antenna is formed in a zig-zag pattern having right angle bends. However, this is only an illustrative example and other patterns such as a spiral pattern, a pattern consisting of plural concentric circles, or the like, without particular limitation thereto, may be employed.

The planar antenna according to example embodiments may also have substantially the same size as the circuit board or be larger than the same, which is sufficient to simultaneously heat and bond a plurality of flip chips arranged on a large area circuit board. As a result, a processing time may be considerably reduced, compared to a typical process that conducts inductive heating of a circuit board having plural flip chips arranged thereon while feeding the same in a desired (or alternatively predetermined) direction.

After fixing the planar antenna to the metal chamber in operation 230, the planar antenna is inserted into the through-hole made of an insulating material and connected to a ground and a high frequency AC power supply via a connection terminal protruding from an outer side of the metal chamber, in operation 240.

Accordingly, the planar antenna receives high frequency AC power to form an AC magnetic field and the flip chips are inductively heated by the AC magnetic field, which are in turn bonded to the circuit board.

Since the planar antenna and the circuit board are spaced from each other by a desired (or alternatively predetermined) gap (2 to 3 mm), when high frequency AC power is applied to the planar antenna, arc discharge may occur between the planar antenna and the circuit board.

In order to reduce (and/or prevent) the arcing, according to the example embodiments, the planar antenna may include a balance capacitor connection terminal at one side thereof, to which a balance capacitor is connected, in operation 250.

Furthermore, another balance capacitor may be connected to the other side of the planar antenna (that is, at the opposite side of the balance capacitor connection terminal).

As such, since the balance capacitors having capacitive impedance are connected to both opposite sides of the planar antenna, the impedance of the planar antenna is decreased, thus effectively reducing (and/or preventing) arc discharge.

In the case where a plurality of flip chips is bonded to a large area circuit board, an AC magnetic field formed in a planar antenna should be uniform. According to example embodiments, in order to improve uniformity of the AC magnetic field formed around the planar antenna, a metal frame is prepared around the planar antenna, in operation 260.

The metal frame is spaced from the planar antenna by a desired (or alternatively predetermined) interval. Also, the metal frame may be configured in a closed loop form to surround a peripheral side of the planar antenna except top and bottom surfaces thereof.

The metal frame is made of Cu having a relatively high conductivity and, therefore, induced current flows through the metal frame and create an induced magnetic field influencing the AC magnetic field created around the planar antenna, thereby improving uniformity of the AC magnetic field.

As described above, a flip chip bonding apparatus and a manufacturing method thereof according to example embodiments may apply AC power to a planar antenna and, using an AC magnetic field created by the applied AC power, may uniformly heat flip chips and a circuit board. Consequently, overheating of the circuit board and/or flip chip bonding faults due to induction of non-uniform magnetic field may be reduce (and/or effectively prevented).

Moreover, using a zig-zag type planar antenna greater than a large area circuit board, numerous flip chips may be bonded to the circuit board at once, thereby considerably reducing the processing time.

While some example embodiments have been particularly shown and described, it will be understood by one of ordinary skill in the art that variations in form and detail may be made therein without departing from the spirit and scope of the claims.

1. A flip chip bonding apparatus comprising:
a metal chamber;
a stage in the metal chamber,
the stage configured to receive a circuit board having one or more flip chips arranged thereon; and
a planar antenna in the metal chamber,
the antenna configured to bond the flip chips to the circuit board by inductively heating the flip chips on the circuit board.

2. The flip chip bonding apparatus according to claim 1, further comprising:
a metal frame,
the metal frame apart from the planar antenna by a gap,
the metal frame configured to allow a uniform AC magnetic field to be generated around the planar antenna.

3. The flip chip bonding apparatus according to claim 2, wherein
the planar antenna includes a peripheral side, a top surface, and a bottom surface, and
the metal frame surrounds the peripheral side of the planar antenna.

4. The flip chip bonding apparatus according to claim 1, wherein
the planar antenna includes a zig-zag form,
a width of the planar antenna is about equal to or greater than a width of the circuit board, and
a breadth of the planar antenna is about equal to or greater than a breadth of the circuit board.

5. The flip chip bonding apparatus according to claim 1, further comprising:
a metal plate below the circuit board,
wherein the metal plate defines a plurality of vacuum holes,
the vacuum holes are arranged at an interval, and
the vacuum holes are configured to be vacuum chucked in order to reduce the circuit board from being bent.

6. The flip chip bonding apparatus according to claim 5, wherein
the metal plate includes a nickel-iron alloy.

7. The flip chip bonding apparatus according to claim 1, wherein
the metal chamber defines a through-hole, and
the planar antenna is fixed above the stage via the through-hole.

8. The flip chip bonding apparatus according to claim 1, further comprising:
a first terminal and a second terminal,
the first and second terminals both connected to a side of the planar antenna;
a high frequency AC power supply connected to the first terminal; and
a ground connected to the second terminal.

9. The flip chip bonding apparatus according to claim 8, wherein
the metal chamber defines at least one through-hole, and
the first and second terminals are in the at least one through-hole, and
the first and second terminals are configured to fix the planar antenna above the stage.

10. The flip chip bonding apparatus according to claim 8, further comprising:
a third terminal and a fourth terminal,
the third and fourth terminals both connected to an opposite side of the planar antenna;
a first balance capacitor connected to the third and fourth terminals; and
a second balance capacitor is connected to the second terminal and the ground,
wherein the first balance capacitor and the second balance capacitor are configured to reduce arc discharge between the circuit board and the planar antenna.

11-19. (canceled)
